(19) United States
(12) Patent Application Publication
(10) Pub. No.: US 2012/0050802 A1
(43) Pub. Date: Mar. 1, 2012

(54) INTERACTION SYSTEM, IMAGE PROCESSING APPARATUS AND INTERACTION CONTROL METHOD

(75) Inventor: Masaya MASUDA, Kanagawa (JP)

(73) Assignee: RICOH COMPANY, LTD., Tokyo (JP)

(21) Appl. No.: 13/215,347

(22) Filed: Aug. 23, 2011

(30) Foreign Application Priority Data
Aug. 31, 2010 (JP) NO. 2010-194816
Jul. 1, 2011 (JP) NO. 2011-147392

(51) Int. Cl. G06F 3/12

(52) U.S. Cl. 358/1.15

(57) ABSTRACT

An interaction system interacts with a distribution system and a core system including a storage to store image data distributed from the distribution system at a predetermined storage location. The distribution system includes an acquiring part to acquire the image data, a distributing part to distribute the acquired image data to the core system, a storage to store distribution destination information indicating a storage location of the distributed image data in the core system, a display control part to control a display of information related to the distributed image data and acquired from the core system, based on the distribution destination information, and a processing part to execute a process with respect to the distributed image data.

### CROSS-REFERENCE TO RELATED APPLICATIONS

This application claims the benefit of Japanese Patent Applications No. 2010-194816 filed on Aug. 31, 2010 and No. 2011-147392 filed on Jul. 1, 2011, in the Japanese Patent Office, the disclosures of which are hereby incorporated by reference.

### BACKGROUND OF THE INVENTION

1. Field of the Invention

The present invention relates to an interaction system, an image processing apparatus, and an interaction control method. The present invention also relates to a non-transitory computer-readable storage medium that stores a program which, when executed by a computer, causes the computer to perform an interaction control process.

2. Description of the Related Art

Recently, many companies are arranging or connecting equipments having an image input function and/or an image output function, such as a MFP (Multi-Function Peripheral), to a network to form a network structure having such functions. The image input function and/or the image output function may have an important role in improving work efficiency, particularly in an image distribution system that provides efficient digitization of paper documents into electronic documents and distribution of the electronic documents.

One important constituent element of the image distribution system may be an image input equipment, such as a scanner, and an image distribution apparatus. A plurality of distribution process menus to suit various kinds of work and usage may be registered in advance in the image distribution apparatus. In this case, a user may select a process menu suited for the work on an operation panel of the scanner in order to scan the paper document, for example.

For example, a Japanese Laid-Open Patent Publication No. 2006-018640 proposes a first system that provides a distribution process and an image conversion process in the form of plug-ins. The user or a manager may arbitrarily combine such plug-ins and form flows for the input process, the image conversion process, and the output process, in order to create a distribution flow from such flows. The created distribution flow may be used to perform the distribution process.

On the other hand, a technique has been proposed to identify a distribution route of a specific document in an image distribution system. For example, a Japanese Laid-Open Patent Publication No. 2006-318212 proposes a second system that manages a distribution log of image data in order to improve security of information that is distributed.

However, according to the first system described above, the complexity of processing the data after the distribution increases as the amount of data to be distributed increases and/or the number of kinds of data to be distributed increases. For example, the amount of data to be distributed to a core system (or enterprise system) may be extremely large, and the distributed data may be stored in a folder located in a low hierarchical level of the core system having a hierarchical folder structure with a large number of hierarchical levels. In this case, a troublesome and time consuming operation may be required to search for the distributed data in the low hierarchical level, and it may be difficult to process the distributed data due to the difficulty of the search.

On the other hand, even when the distribution log is managed as in the second system described above, no practical method has been proposed to search or make reference to data of the distribution log or to process the data of the distribution log. For this reason, after the data is distributed to the core system, for example, it may be difficult to process the distributed data, and there is no desirable interaction between the image distribution system and the core system.

### SUMMARY OF THE INVENTION

Accordingly, it is a general object in one embodiment of the present invention to provide a novel and useful interaction system, image processing apparatus, interaction control method, and non-transitory computer-readable storage medium, in which the problem described above may be suppressed.

Another and more specific object in one embodiment of the present invention is to provide an interaction system, an image processing apparatus, an interaction control method, and a non-transitory computer-readable storage medium, that may provide interaction between an image distribution system and a core system, and may facilitate processing of data distributed to the core system.

According to one aspect of the present invention, there is provided an interaction system configured to interact with a distribution system and a core system, the core system including a first storage configured to store image data distributed from the distribution system at a predetermined storage location; the distribution system having a processor including an acquiring part configured to acquire the image data; a distributing part configured to distribute the acquired image data to the core system; a second storage configured to store distribution destination information indicating a storage location of the distributed image data in the core system; a display control part configured to control a display of information related to the distributed image data and acquired from the core system, based on the distribution destination information; and a processing part configured to execute a process with respect to the distributed image data.

According to another aspect of the present invention, there is provided an image processing apparatus connectable to an image distribution server and a core system via a network, including a processor, wherein the processor includes a requesting part configured to request acquisition of distribution destination information indicating a storage location of image data distributed from the image distribution server to the core system, with respect to the image distribution server; an acquiring part configured to acquire the distribution destination information from the image distribution server; a display control part configured to acquire information related to the distributed image data from the core system based on the acquired distribution destination information, and to control a display of the information related to the distributed image data; and a processing part configured to process the distributed image data.

According to another aspect of the present invention, there is provided a non-transitory computer-readable storage medium that stores a program which, when executed by a computer, causes the computer to perform an interaction control process of an image processing apparatus that is connectable to an image distribution server and a core system via a network, the interaction control process including a requesting procedure causing the computer to request acquisition of distribution destination information indicating a storage location of image data distributed from the image distribution server to the core system, with respect to the image distribution server; an acquiring procedure causing the computer to acquire the distribution destination information from the image distribution server; a display control procedure causing the computer to acquire information related to the distributed image data from the core system based on the acquired distribution destination information, and to control a display of the information related to the distributed image data; and a processing procedure causing the computer to process the distributed image data.

Other objects and further features of the present invention will be apparent from the following detailed description when read in conjunction with the accompanying drawings.

### BRIEF DESCRIPTION OF THE DRAWINGS

FIG. 1 is a diagram illustrating an example of an interaction system in a first embodiment of the present invention;

FIG. 2 is a block diagram illustrating an example of a hardware structure of a MFP in the first embodiment;

FIG. 3 is a block diagram illustrating an example of a hardware structure of an image distribution apparatus in the first embodiment;

FIG. 4 is a block diagram illustrating an example of functions of the MFP in the first embodiment;

FIG. 5 is a flow chart for explaining an example of a distribution process of the MFP in the first embodiment;

FIG. 6 is a block diagram illustrating an example of functions of the image distribution apparatus in the first embodiment;

FIG. 7 is a diagram illustrating an example of image data;

FIG. 8 is a diagram illustrating an example of a data structure of distribution information;

FIG. 9 is a diagram illustrating an example of detailed information of the image data;

FIG. 10 is a block diagram illustrating an example of functions of a core system in the first embodiment;

FIG. 11 is a diagram illustrating an example of a display screen of a list of distributed image data and processing items;

FIG. 12 is a flow chart for explaining an example of a distribution process of the image distribution apparatus in the first embodiment; and

FIG. 13 is a flow chart for explaining an example of an interaction control process in the first embodiment.

### DESCRIPTION OF THE PREFERRED EMBODIMENTS

A description will be given of embodiments of an interaction system, an image processing apparatus, an interaction control method, and a non-transitory computer-readable storage medium according to the present invention, by referring to the drawings.

In the embodiments described hereunder, a MFP (Multi-Function Peripheral) is an example of an image input apparatus that inputs image data. The MFP includes, within a single housing or casing or package thereof, a printer function, a scanner function, a copy function, and a facsimile function.

### First Embodiment

<System & Hardware>

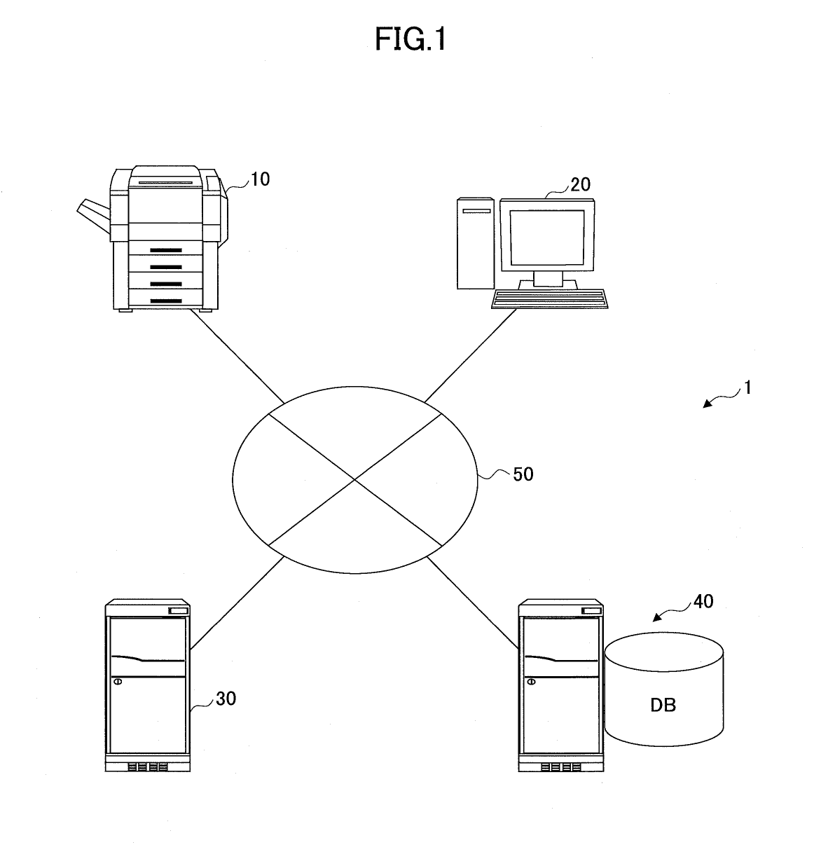

FIG. 1 is a diagram illustrating an example of an interaction system in a first embodiment of the present invention. An interaction system 1 includes a MFP (Multi-Function Peripheral) 10, an information processing terminal 20, an image distribution apparatus 30, and a core system 40 that are connected via a network 50. For example, the information processing terminal 20 may be formed by a PC (Personal Computer) or a PDA (Personal Digital Assistant). The image distribution apparatus 30 may be formed by a distribution server. The core system 40 may be formed by an enterprise system or a core enterprise system. In this example, the MFP 10 and the image distribution apparatus 30 form an image distribution system.

The MFP 10 includes, within a single housing or casing or package thereof, a printer function, a scanner function, a copy function, and a facsimile function. The MFP 10 may scan a paper document or the like by the scanner function to generate image data, and send the generated image data to the image distribution apparatus 30. The details of the MFP 10 will be described later. In addition, the image data may include image data of the document. The MFP 10 may be regarded as an image processing apparatus in that the MFP 10 processes images.

The information processing terminal 20 creates a distribution flow when a managing tool related to a data distribution is started by a manager and each of plug-ins of the output process is selected in an order after performing an image conversion. The created distribution flow is stored in the image distribution apparatus 30.

The image distribution apparatus 30 may be formed by a computer, such as a work station, that receives the image data obtained by the scanning in the MFP 10, and executes various processes including a distribution process according to a specified distribution flow. The distribution flow may include a mail transmission, a facsimile transmission, a folder distribution, and the like.

The image distribution apparatus 30 also forms a server that executes the distribution flow based on the received image data, and executes processes such as a document storing process and a distribution process according to the distribution flow created by a user. The details of the image distribution apparatus 30 will be described later. The MFP 10 may include the image distribution apparatus 30 as a built-in apparatus thereof, and in this case, the distribution flow may be created by the MFP 10.

The core system 40 may be formed by a system for processing sales, inventory and finance that are directly related to business outline or service, a system forming a core of the business and services, or the like of enterprise information systems. The core system 40 processes a large amount of data.

The number of MFPs 10, the number of information processing terminals 20, and the number of image distribution apparatuses 30 that are connected via the network 50 may be set arbitrarily. In addition, the interaction system 1 may further include a mail distribution server and the like. The interaction system 1 at least includes one MFP 10 and one image distribution apparatus 30.

Of course, the network 50 may be formed by an arbitrary combination of networks.

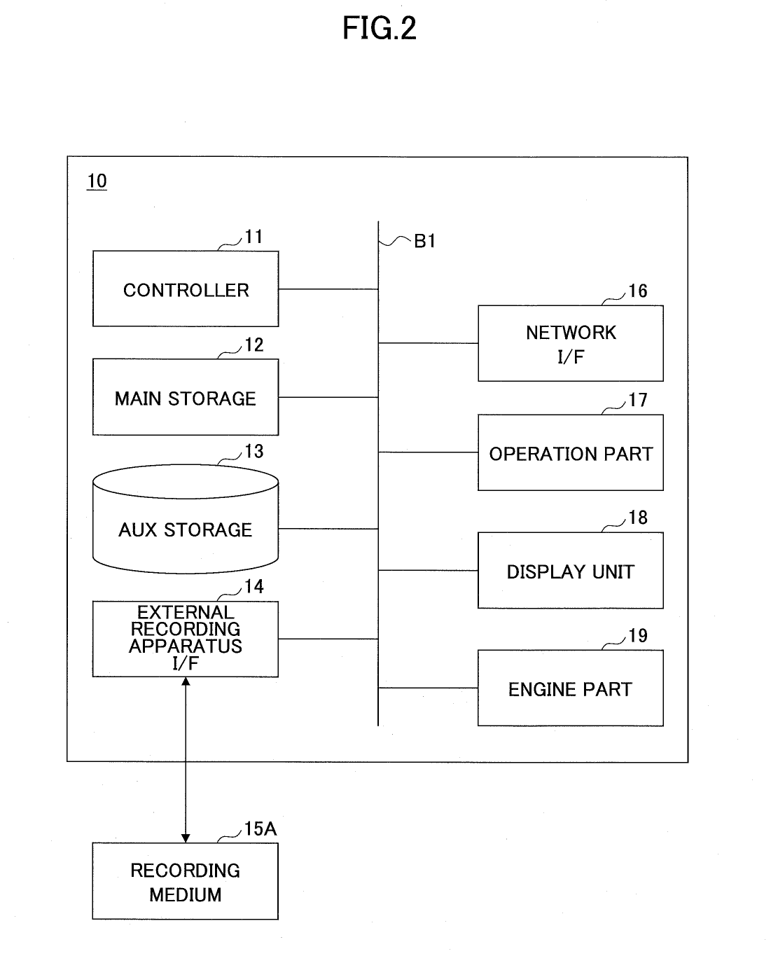

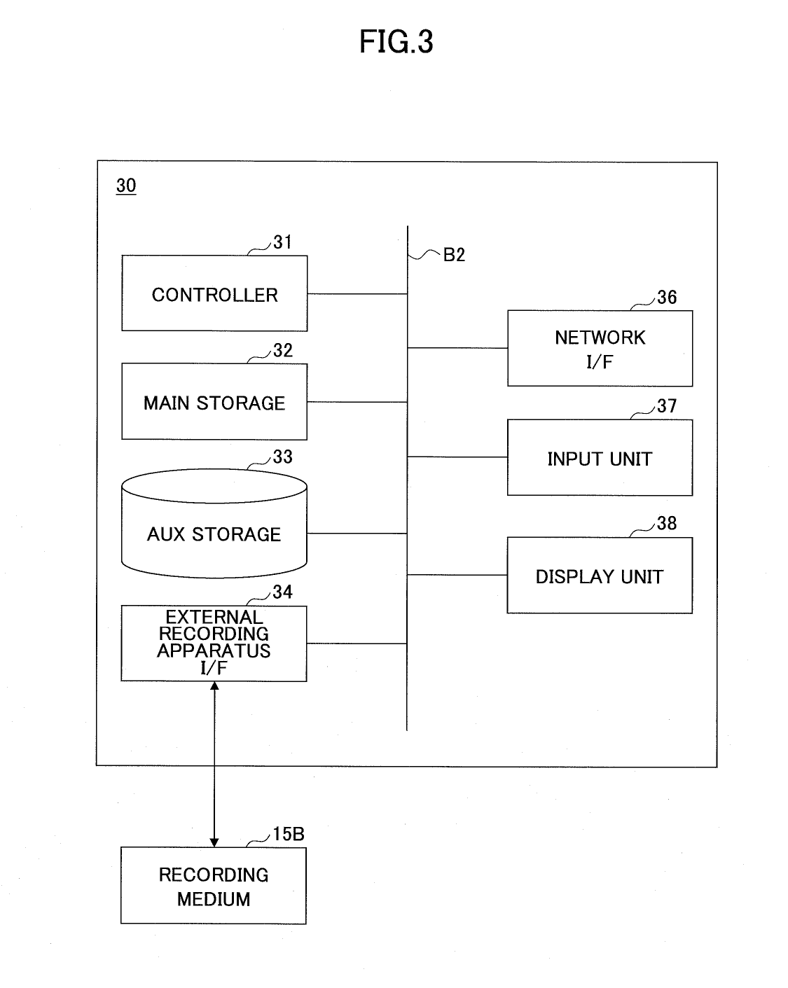

Next, a description will be given of hardware structures of the MFP 10 and the image distribution apparatus 30 in the first embodiment, by referring to FIGS. 2 and 3.

FIG. 2 is a block diagram illustrating an example of the hardware structure of the MFP in the first embodiment. The MFP 10 includes a controller 11, a main storage 12, an auxiliary (or secondary) storage 13, an external recording apparatus interface (I/F) 14, a network interface (I/F) 16, an operation part 17, a display unit 18, and an engine part 19 that are communicatably connected via a bus B1 to exchange data.

The controller 11 may be formed by a processor, such as CPU (Central Processing Unit), that controls parts of the MFP 10 and perform operations (or computations) or processes on the data. The controller 11 may execute programs stored in the main storage 12 in order to receive the data from the main storage 12, the auxiliary storage 13, the operation part 17 and the like, and to output the data after performing the operations or processes to the main storage 12, the auxiliary storage 13, the engine part 19 and the like.

The main storage 12 may be formed by a ROM (Read Only Memory), a RAM (Random Access Memory), and the like. The main storage 12 stores or, temporarily stores, data and programs to be executed by the controller 11. The programs to be executed by the controller 11 may include a basic software, such as an OS (Operating System), and application software.

The auxiliary storage 13 may be formed by a HDD (Hard Disk Drive), and the like. The auxiliary storage 13 stores data related to the application software.

The external recording apparatus I/F 14 provides an interface between the MFP 10 and a recording medium 15A that connects to the MFP 10 via a data channel such as a USB (Universal Serial Bus). For example, the recording medium 15A may be formed by a flash memory. The recording medium 15A may store programs to be installed in the MFP 10 via the external recording apparatus I/F 14, so that the MFP 10 may execute such programs.

The network I/F 16 provides an interface between the MFP 10 and a peripheral equipment that has a communication function and connects to the MFP 10 via a network, such as a LAN (Local Area Network) and a WAN (Wide Area Network). The network may be formed by a data channel such as a cable and/or a wireless line.

The operation part 17 may include a plurality of keys or switches (hard keys) or, touchscreen keys or switches (virtual keys). The display unit 18 may be formed by a LCD (Liquid Crystal Display) and the like. The operation part 17 and the display unit 18 may be integrally provided in a single operation panel or, a touchscreen panel, in order to provide a GUI (Graphical User Interface). The operation part 17 and the display unit 18 function as a UI (User Interface) for the user to input information and to display information with respect to the user when utilizing the functions of the MFP 10.

The engine part 19 may function as an image data input unit and an image data output unit, in order to perform operations such as reading a paper document and printing the read document on a recording medium such as paper. The engine part 19 may include a scanner engine, a print engine, a search engine, and the like.

FIG. 3 is a block diagram illustrating an example of the hardware structure of the image distribution apparatus in the first embodiment. The image distribution apparatus 30 includes a controller 31, a main storage 32, an auxiliary (or secondary) storage 33, an external recording apparatus interface (I/F) 34, a network interface (I/F) 36, an input unit 37, and a display unit 38 that are communicatably connected via a bus B2 to exchange data.

The controller 31 may be formed by a processor, such as CPU (Central Processing Unit), that controls parts of the image distribution apparatus 30 and perform operations (or computations) or processes on the data. The controller 31 may execute programs stored in the main storage 32 in order to receive the data from the main storage 32, the auxiliary storage 33, the input unit 37 and the like, and to output the data after performing the operations or processes to the main storage 32, the auxiliary storage 33, and the like.

The main storage 32 may be formed by a ROM (Read Only Memory), a RAM (Random Access Memory), and the like. The main storage 32 stores or, temporarily stores, data and programs to be executed by the controller 31. The programs to be executed by the controller 31 may include a basic software, such as an OS (Operating System), and application software.

The auxiliary storage 33 may be formed by a HDD (Hard Disk Drive), and the like. The auxiliary storage 33 stores data related to the application software.

The external recording apparatus I/F 34 provides an interface between the image distribution apparatus 30 and a recording medium 15B that connects to the image distribution apparatus 30 via a data channel such as a USB (Universal Serial Bus). For example, the recording medium 15B may be formed by a flash memory. The recording medium 15B may store programs to be installed in the image distribution apparatus 30 via the external recording apparatus I/F 34, so that the image distribution apparatus 30 may execute such programs. The recording medium 15B may be the same as or, may be different from the recording medium 15A illustrated in FIG. 2.

The network I/F 36 provides an interface between the image distribution apparatus 30 and a peripheral equipment that has a communication function and connects to the image distribution apparatus 30 via a network, such as a LAN (Local Area Network) and a WAN (Wide Area Network). The network may be formed by a data channel such as a cable and/or a wireless line.

The input unit 37 may include a keyboard, and a pointing device such as a mouse and a touchpad. The keyboard may include cursor keys, alphanumeric keys, and function keys for selecting various functions. The pointing device may be used to move a cursor and select a button or the like on a display screen of the display unit 38. The input unit 37 provides a UI (User Interface) for the user to input information, including operation instructions, to the controller 31.

The display unit 38 may be formed by a CRT (Cathode Ray Tube), a LCD (Liquid Crystal Display), and the like to display various information, including display data from the controller 31. The display unit 38 provides a UI (User Interface) to display information with respect to the user when utilizing the functions of the image distribution apparatus 30.

<Functions>

1. MFP

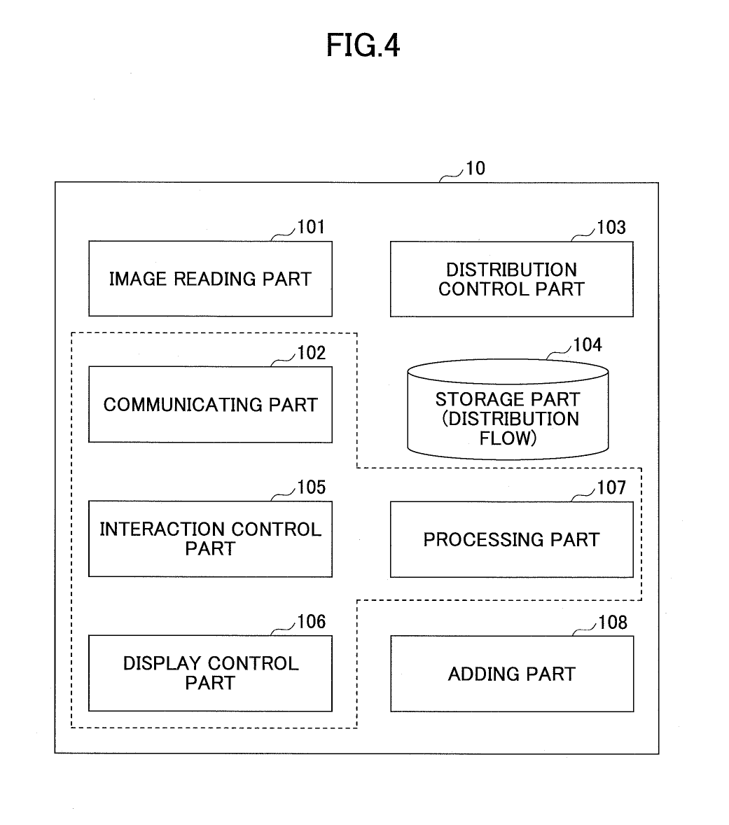

FIG. 4 is a block diagram illustrating an example of functions of the MFP in the first embodiment. As illustrated in FIG. 4, the MFP 10 includes an image reading part 101, a communicating part 102, a distribution control part 103, a storage part 104, an interaction control part 105, a display control part 106, a processing part 107, and an adding part 108. The illustration of known function parts of the MFP 10, including a printer function, a scanner function, a copy function, and a facsimile function will be omitted in FIG. 4.

The image reading part 101 acquires image data that is read from a document by the scanner function. The image data acquisition is not limited to that from the scanner function, and may be acquired from the facsimile function, the information processing terminal 20, a hot folder on the network 50, and the like.

The communicating part 102 communicates with an external equipment to exchange equipment information, image data, and the like. When a processing request to process the distribution flow of the image data is instructed from the user, the communicating part 102 sends the image data and the processing request to the image distribution apparatus 30. In addition, the communicating part 102 sends to the image distribution apparatus 30 an acquisition request for the distribution information including distribution destination information indicating a distribution destination (storage location in case the distribution destination is a folder) of the image data. In this state, the communicating part 102 also sends a user ID of the user who logged in to an external interactive application which will be described later. The communicating part 102 may receive the distribution information from the image distribution apparatus 30.

The distribution control part 103 accepts specifying (or selection) of the distribution flow from the user. The distribution flow may be specified from the operation panel (operation part 17 and display unit 18) of the MFP 10. The specifiable (or selectable) distribution flows may be acquired from the storage part 104 or the like. In this state, bibliographical information of processes included in the distribution flow may be input by the user. For example, the bibliographical information includes an image format, an image size, and the like in the case of the image conversion process, and the bibliographical information includes a mail address of the distribution destination, and the like in the case of the mail distribution. The user ID of the bibliographical information may be acquired from log-in information of the user who logged in to the image distribution system.

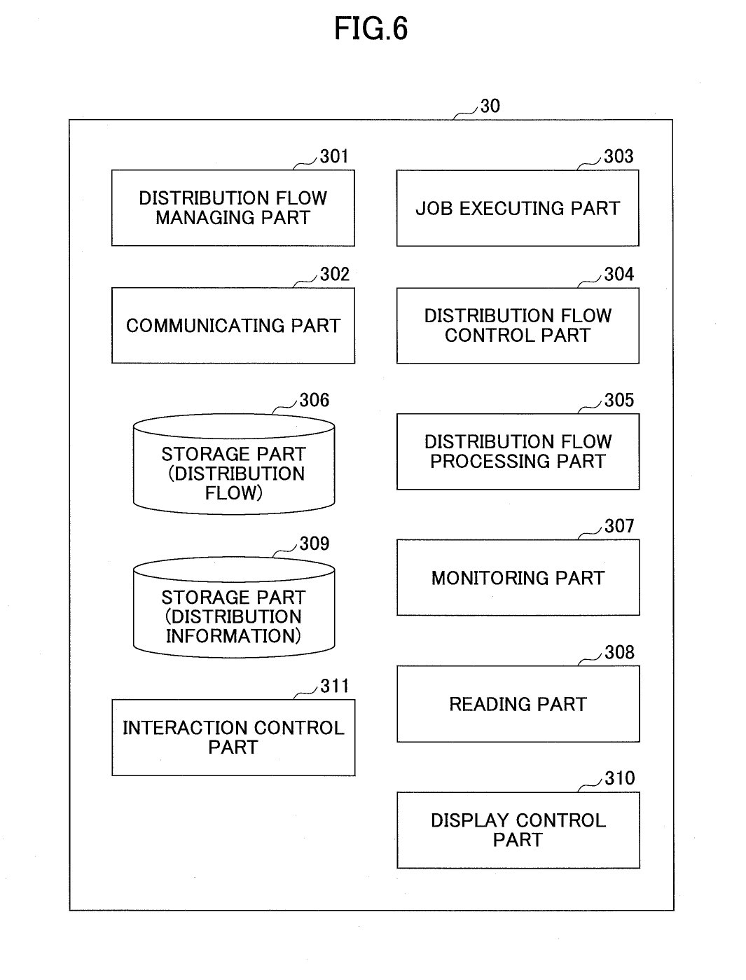

The storage part 104 stores each of the plug-ins of the image conversion process, the output process, and the like. In addition, the storage part 104 stores one or a plurality of distribution flows that are combinations of the plug-ins. The storage part 104 may be omitted by acquiring the information related to the distribution flow from a storage part 306 of the image distribution apparatus 30 illustrated in FIG. 6 which will be described later.

The interaction control part 105 makes an acquisition request for the distribution information with respect to the image distribution apparatus 30 via the communicating part 102. For example, the interaction control part 105 outputs the acquisition request for the distribution information with respect to the image distribution apparatus 30 using a HTTP (Hyper Text Transfer Protocol). The distribution information includes the distribution destination information indicating the storage location of the distributed image data, the user ID, and the like. When the interaction control part 105 acquires the distribution information, the interaction control part 105 acquires via the communicating part 102 the information related to the image data from the storage location in the core system 40 using the distribution destination information included in the distribution information. The image data may be acquired from the core system 40 using a public API (Application Programming Interface). The interaction control part 105 outputs the acquired information related to the image data to the display control part 106.

The display control part 106 performs a control to display on the display unit 18 a list of the information related to the image data and acquired from the interaction control part 105. For example, the information related to the image data may include a file name, a file size, and the like. The display control part 106 also performs a control to display on the display unit 18 process buttons with respect to the displayed image data. The display control part 106 detects the process button specified by the user, and makes an execute request corresponding to the specified process with respect to the processing part 107.

The processing part 107 performs a process requested by the execute request from the display control part 106 with respect to the image data that is a processing target. The processing part 107 makes an image data processing request with respect to the equipment that executes the requested process. The requested process may include a print process, a distribution process, a storage location modify process, and the like. In addition, the processing part 107 distributes the acquired image data, added with a QR (Quick Response) code (registered trademark) by the adding part 108, to a monitoring folder which will be described later.

The adding part 108 adds the QR code to the image data acquired by the image reading part 101. The QR code that is added is used when processing the image data, as will be described later. For example, the QR code may be embedded with distribution information such as a path of the image data at the storage location, a transmitting source, and the like.

The adding part 108 may add other two-dimensional codes or bar codes in place of the QR code. Examples of the two dimensional codes include PDF417 (registered trademark) of Symbol Technologies, DataMatrix (registered trademark) of CT Matrix, and MaxiCode (registered trademark) of UPS. The adding part 108 may be provided as an optional function of the MFP 10.

Functions of the communicating part 102, the interaction control part 105, the display control part 106, and the processing part 107 that are surrounded by dotted lines in FIG. 4 and exchange data with the image distribution apparatus 30 and the core system 40 and perform processes on the distributed data may be provided as external interaction applications or programs. For example, the functions of the external interaction application may be utilized on condition that a log-in is made thereto.

The image reading part 101 may be realized by the scanner function of the engine part 19. The distribution control part 103, the interaction control part 105, the display control part 106, the processing part 107, and the adding part 108 may be realized by the controller 11 and the main storage 12 that provides a work memory. The communicating part 102 may be realized by the controller 11 and the network I/F 16 controlled thereby. The storage part 104 may be realized by the auxiliary storage 13.

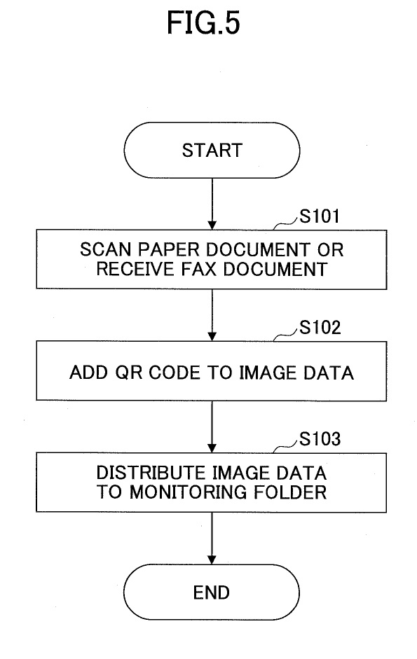

Next, a description will be given of the distribution process to distribute the image data from the MFP 10 to the image distribution apparatus 30. FIG. 5 is a flow chart for explaining an example of the distribution process of the MFP in the first embodiment. In a step S101 illustrated in FIG. 5, the image reading part 101 acquires the image data by scanning (or reading) the paper document. The MFP 10 may acquire the image data by receiving a facsimile document. In a step S102, the image reading part 101 adds the QR code to the acquired image data. The QR code may be embedded with the distribution information such as the path of the image data at the storage location, the transmitting source, and the like. In a step S103, the processing part 107 distributes the image data added with the QR code to the monitoring folder which will be described later.

2. Image Distribution Apparatus

Next, a description will be given of the functions of the image distribution apparatus 30, by referring to FIG. 6. FIG. 6 is a block diagram illustrating an example of functions of the image distribution apparatus in the first embodiment. The image distribution apparatus 30 illustrated in FIG. 6 includes a distribution flow managing part 301, a communicating part 302, a job executing part 303, a distribution flow control part 304, a distribution flow processing part 305, a storage part 306, a monitoring part 307, a reading part 308, a storage part 309, a display control part 310, and an interaction control part 311.

The distribution flow managing part 301 stores a distribution flow that is set into the storage part 306 in XML (eXtensible Markup Language), for example, when the user sets the distribution flow that is an arbitrary combination of the plug-ins of the image conversion process, the output process, and the like. The distribution flow managing part 301 controls the UI screen and the like that is displayed on the information processing terminal 20 for setting the distribution flow. In addition, the distribution flow managing part 301 functions as a managing tool of the image distribution system.

The communicating part 302 transmits and receives the equipment information, the image data, and the like. Particularly, the communicating part 302 receives the image data from the MFP 10, and sends the image data after the image processing with respect to the distribution destination of the distribution flow.

The communication part 302 receives identification information of the distribution flow, the bibliographical information of each process of the distribution flow, and the like from the MFP 10. When the communicating part 302 receives the request (or job request) to process the distribution flow from the MFP 10, the communicating part 302 outputs the identification information of the distribution flow, the bibliographical information of each process of the distribution flow, and the like to the job executing part 303.

Further, when the communicating part 302 receives an acquisition request for the distribution information including the log-in user ID of the external interaction application from the MFP 10, the communicating part 302 notifies the reception of this acquisition request to the interaction control part 311. When the communicating part 302 acquires the distribution information from the interaction control part 311, the communicating part 302 outputs the acquired distribution information to the MFP 10.

The job executing part 303 executes a job requested from the MFP 10. The executing part 303 makes a request to process the distribution flow with respect to the distribution flow control part 304, and outputs the identification information of the distribution flow, the bibliographical information of each process of the distribution flow, and the image data.

When the distribution flow control part 304 receives the request to process the distribution flow from the job executing part 303, the distribution flow control part 304 controls execution of each process included in the distribution flow. When the distribution flow control part 304 acquires the image data from the monitoring part 307, the distribution flow control part 304 performs a control to distribute the image data to the core system 40 after performing a predetermined image processing (for example, PDF (Portable Document Format) conversion). In this state, the distribution flow control part 304 may determine the storage location in the core system 40 based on the information added to the image data. For example, when an OCR (Optical Character Recognition) process is performed, and a data classification included in the image data, a company name of the transmitting source, and the like are acquired, the distribution flow control part 304 may determine as the storage location a folder that has the same company name and is located in a hierarchical level lower than that of the folder indicating the data classification.

When the distribution flow processing part 305 receives an instruction to control the distribution flow from the distribution flow control part 304, the distribution flow processing part 305 executes the distribution flow according to the instruction to perform a distribution process. In other words, the distribution flow processing part 305 executes each process included in the distribution flow in the order of the flow, and distributes the image data to the distribution destination.

Each process performed by the distribution flow processing part 305 may be categorized into the image conversion process, the output process (or distribution process), and the like. The image conversion process includes a process to convert the image data format, such as a PDF (Portable Document Format) conversion and a TIFF (Tagged Image File Format) conversion, and a character recognition process, such as an OCR (Optical Character Recognition) process. The output process includes a process to distribute the acquired image data or the converted image data to the distribution destination, such as a mail distribution server and an image management server. In this example, it is assumed for the sake of convenience that the distribution flow processing part 305 performs at least the output process.

The storage part 306 stores each of the plug-ins of the image conversion process, the output process, and the like. The storage part 306 also stores one or a plurality of distribution flows that are combinations of the plug-ins.

The monitoring part 306 monitors the monitoring folder that is set in advance. The monitoring folder may be provided within the image distribution apparatus 30 or within the information processing terminal 20 that is connected to the image distribution apparatus 30 via the network 50. The monitoring folder may be set in advance by the user.

The monitoring part 307 periodically checks the monitoring folder, and when a newly stored image data is found in the monitoring folder, the monitoring part 307 acquires the newly stored image data. The monitoring part 307 outputs the acquired image data to the reading part 308 and the distribution flow control part 304. The monitoring part 307 performs a similar process with respect to the image data stored in a child folder of the monitoring folder.

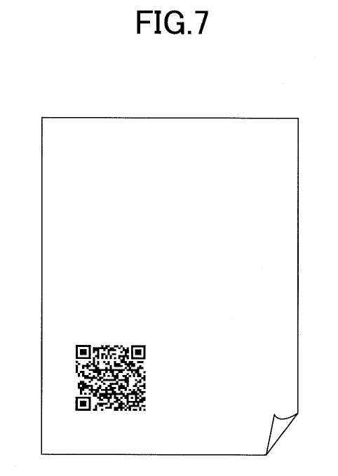

FIG. 7 is a diagram illustrating an example of the image data. As illustrated in FIG. 7, the image data stored in the monitoring folder may be added with the QR code, for example. In this case, the distribution information is embedded in the QR code.

Returning now to the description of FIG. 6, the reading part 308 reads the QR code that is added to the image data acquired by the monitoring part 307. The distribution information is embedded in the QR code, and any suitable identification information that may be embedded with the distribution information, such as the bar code, may be used in place of the QR code. The reading part 308 reads the distribution information of the QR code, and records the read distribution information in the storage part 309.

In addition, even when the QR code is added to the image data that is received from the MFP 10 together with the request to process the distribution flow, the reading part 308 also reads the QR code. In other words, the reading part 308 not only reads the QR coded added to the image data acquired by the monitoring part 307, but also reads the QR code if the QR code is added to the image data received from the image data.

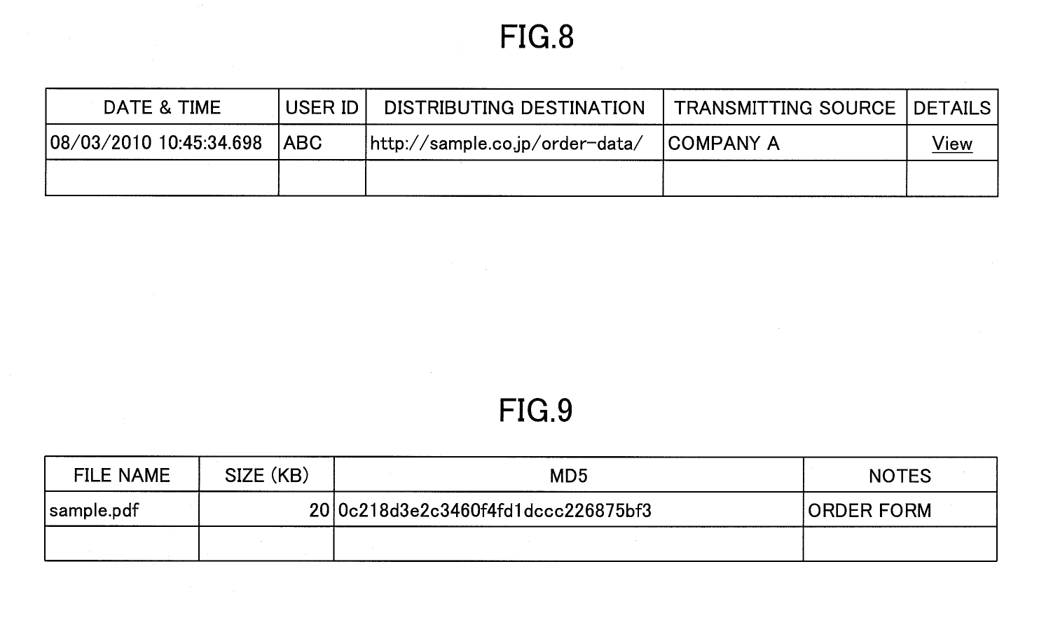

The storage part 309 stores the distribution information read by the reading part 308. FIG. 8 is a diagram illustrating an example of a data structure of the distribution information. As illustrated in FIG. 8, the distribution information includes information related to a distribution date and time, a User ID, a distribution destination, a transmitting source, and details. The information included in the distribution information may be acquired when the reading part 308 reads the QR code. The distribution destination information may indicate a URL (Uniform Resource Locator) of a server in the core system 40. The distribution destination information may indicate the distribution destination path to the folder at the storage location.

Returning now again to the description of FIG. 6, the display control part 310 performs a control to display predetermined data on the display unit 38. For example, the display control part 310 performs a control to display the distribution information. In this case, the display control part 310 may display information illustrated in FIG. 9 when “View” of the distribution information is instructed (or selected).

FIG. 9 is a diagram illustrating an example of detailed information of the image data. The detailed information of the image data may be acquired from the QR code or the like. The displayed detailed information of the image data may include the file name, the file size, the MD5 (Message Digest Algorithm), notes, and the like. The notes included in the detailed information may be acquired from the classification of the image data included in the QR code, for example. The detailed information of the image data illustrated in FIG. 8 may be stored in the storage part 309.

When the interaction control part 311 receives the acquisition request for the distribution information from the communicating part 302, the interaction control part 311 reads from the storage part 309 the distribution information corresponding to the user ID included in the acquisition request. The interaction control part 311 outputs the read distribution information to the MFP 10 via the communicating part 302. In addition, the interaction control part 311 controls the interaction of the image distribution apparatus 30 with the external equipment.

The storage part 306 and the storage part 309 may be realized by the auxiliary storage 33 and/or the main storage 32. The communicating part 302 may be realized by the network I/F 36 or, by the controller 31 and the network I/F 36 controlled thereby. Other parts of the image distribution apparatus 30 may be realized by the controller 31 and the main storage 32 that provides a work memory. Of course, the storage part 306 and the storage part 309 may be formed by the same storage.

3. Core System

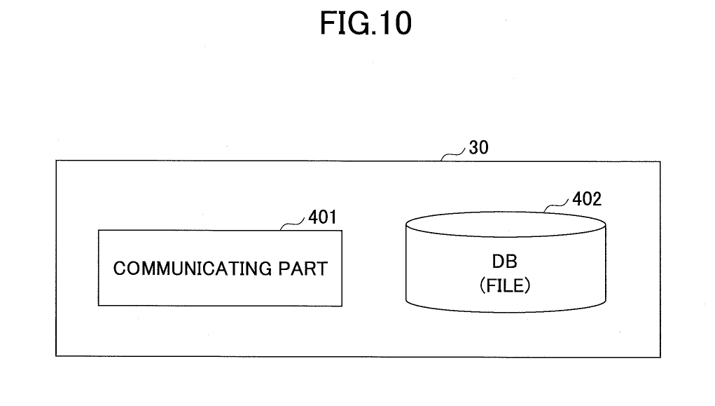

Next, a description will be given of the functions of the core system 40, by referring to FIG. 10. FIG. 10 is a block diagram illustrating an example of the functions of the core system in the first embodiment. As illustrated in FIG. 10, the core system 40 includes a communicating part 401 and DB (Data-Base) 402.

The communicating part 401 exchanges various data, including image data, with the MFP 10 and the image distribution apparatus 30. The DB 402 stores image data using a hierarchical structure of the directory. For example, the DB 402 may store the image data distributed from the image distribution apparatus 30. In this case, the image data is stored at the storage location (for example, folder) that is specified by the image distribution apparatus 30.

Because the core system 40 processes a large amount of data, the hierarchical structure may include a large number hierarchical levels. Hence, when the image data is to be processed after being distributed to the core system 40, it may be difficult to find the location where the image data is stored due to the large number of hierarchical levels.

Hence, the MFP 10 acquires the distribution information stored in the image distribution apparatus 30, and traces the distribution destination information included in the distribution information. As a result, the location where the distributed image data is stored in the core system 30 may be found with ease.

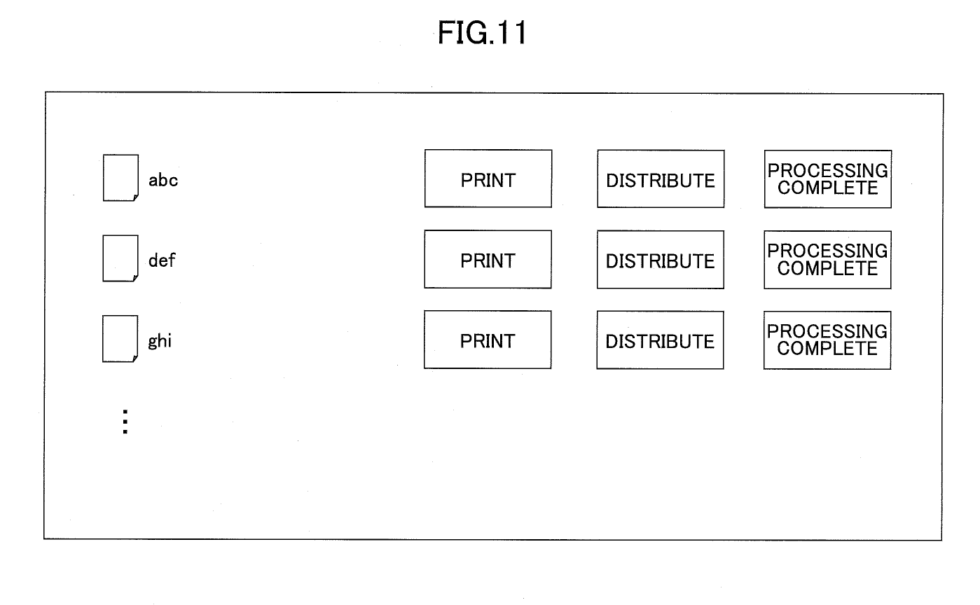

Furthermore, the image data distributed to the core system 40 may be subjected to a processing. FIG. 11 is a diagram illustrating an example of a display screen of a list of distributed image data and processing items. As illustrated in FIG. 11, the file names “abc”, “def” and “ghi” of the distributed image data, and buttons of processing items “print”, “distribute” and “processing complete” with respect to the image data are displayed on the display screen of the operation panel in the operation part 17 (or on the display unit 18) of the MFP 10 using a Web browser, for example.

When the “print” button is selected on the display screen, the processing part 107 executes a print process of the image data corresponding to the selected “print” button. The print process is useful when storing the distributed image data in paper form, for example.

When the “distribute” button is selected on the display screen, the processing part 107 executes a distribution process using the distribution function of the image distribution apparatus 30. First, the processing part 107 instructs the distribution control part 103 to display a distribution flow selection screen. The distribution control part 103 sends to the image distribution apparatus 30 the request to process the selected distribution flow, and the image data acquired from the core system 40 and corresponding to the selected “distribute” button. Hence, the image data that is automatically distributed to the core system 40 may be distributed according to the distribution flow selected by the user. For example, the user may receive the image data distributed to the core system 40 by mail, by selecting the distribution flow to send the image data to the user by mail.

When the “processing complete” button is selected on the display screen, the processing part 107 performs a control in order to modify the storage location in the core system 40. For example, the core system 40 may operate under a condition such that, when the distributed image data is read or processed in the core system 40, the image data is moved to a processed folder. In this case, the MFP 10 may modify the folder of the read or processed image data to the processed folder. More particularly, the processing part 107 may modify the storage location of the image data corresponding to the selected “processing complete” button to the processed folder, and notify the path to the processed folder to the core system 40. Accordingly, the core system 40 may modify the storage location of the read or processed image data to the processed folder, the path to which is notified from the MFP 10.

In this first embodiment, the processes described above may be appropriately combined. For example, after performing the distribution process, the storage location may be modified to the processed folder in the core system 40. Further, after performing the distribution process, a print process may be performed.

<Operation>

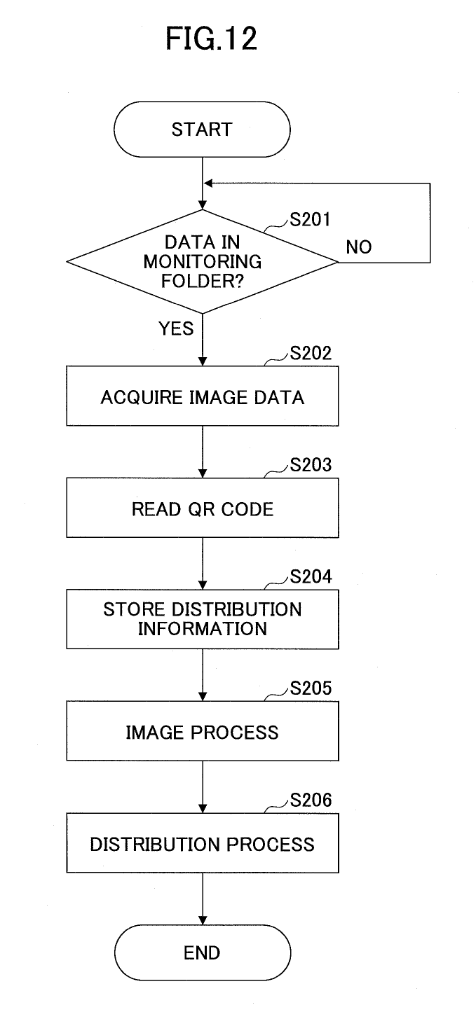

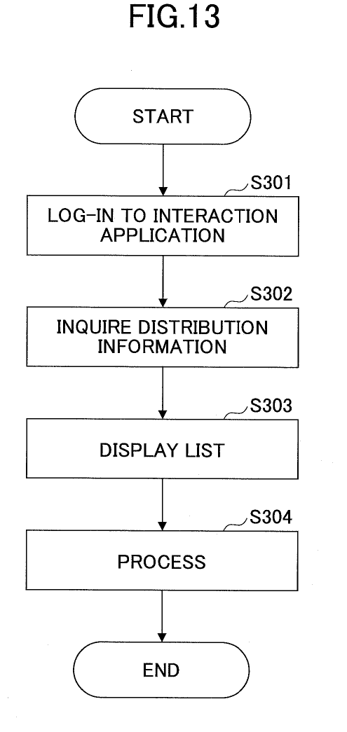

Next, a description will be given of the operation of the interaction system 1 in the first embodiment, by referring to FIG. 12. FIG. 12 is a flow chart for explaining an example of the distribution process of the image distribution apparatus in the first embodiment. In a step S201 illustrated in FIG. 12, the monitoring part 307 decides whether image data is newly stored in the monitoring folder. The monitoring part 307 periodically performs the decision of the step S201 if the decision result in the step S201 is NO. On the other hand, the process advances to a step S202 if the decision result in the step S201 is YES. The monitoring folder may not only store the image data from the MFP 10, but also the image data from other equipments, including the image data added with the QR code.

In the step S202, the monitoring part 307 acquires the image data from the monitoring folder. In a step S203, the reading part 308 reads the QR code added to the image data acquired by the monitoring part 307. In a step S204, the reading part 308 records, in the storage part 309, the distribution information acquired from the read QR code. In a step S205, the distribution flow control part 304 performs a predetermined image processing with respect to the image data acquired by the monitoring part 307. The predetermined image processing may be set in advance when setting the monitoring folder, for example. The predetermined image processing may include a size conversion, a resolution conversion, or the like. The predetermined image processing of the step S205 may be omitted.

In a step S206, the distribution flow control part 304 distributes the image data subjected to the predetermined image processing to the core system 40. In this case, the distribution flow control part 304 acquires the storage location of the image data when the distribution destination information is included in the QR code, and distributes the image data to the storage location. In addition, when the distribution destination information is not included in the QR code, the distribution flow control part 304 determines the storage location (or path thereto) based on other information included in the QR code. For example, the storage location may be determined using the company name of the transmitting source, the user ID, and the like included in the QR code.

Accordingly, the distribution information of the image data stored in the monitoring folder is stored in the image distribution apparatus 30. In addition, the image data stored in the monitoring folder may be automatically distributed to the core system 40 using a predetermined path that is specified.

FIG. 13 is a flow chart for explaining an example of an interaction control process in the first embodiment. In a step S301 illustrated in FIG. 13, the user makes a log-in to the external interaction application from the MFP 10.

In a step S302, the interaction control part 105 makes an acquisition request for the distribution information with respect to the user ID of the user who made the log-in, with respect to the image distribution apparatus 30. In a step S303, the interaction control part 105 outputs the distribution information acquired from the image distribution apparatus 30 to the display control part 106. The display control part 106 traces the path indicated by the distribution destination included in the acquired distribution information, and acquires the image data from the core system 40. The display control part 106 performs a control in order to display on the operation panel a list of the acquired image data.

In a step S304, the processing part 107 executes a process with respect to the distributed image data in response to an instruction input by the user. The process may be a print process, a distribution process, and a storage location modify process to modify the folder at the storage location.

Therefore, according to the first embodiment, interaction is achieved between the image distribution system and the core system, in order to facilitate processing of the data distributed to the core system.

In addition, when the MFP 10 is provided with a search engine, the MFP 10 may perform a search when acquiring the distributed image data from the core system 40, in order to display a list of the image data matching a search condition. For example, the list may include the image data whose transmitting source is a predetermined company or, include the image data distributed on a specific date and time.

Even when the image data scanned by the MFP 10 is added with the QR code and the image data is distributed to the core system 40, the image distribution apparatus 30 may store the distribution information in the storage part 309.

### Second Embodiment

Next, a description will be given of a second embodiment of the present invention. In this second embodiment, the image distribution apparatus is built into the MFP. The hardware structure of the MFP may be the same as that of the first embodiment described above.

The functions of the MFP having the image distribution apparatus as a built-in apparatus thereof may basically be the same as the functions of the MFP illustrated in FIG. 4 and the functions of the image distribution apparatus illustrated in FIG. 5. Hence, according to the MFP in this second embodiment, the processes of the first embodiment may be performed by a single MFP.

The external interaction application may be installed in an equipment other than the MFP. For example, the external interaction application may be installed in an information processing apparatus (for example, PC).

The program executed in the image distribution apparatus in the first embodiment and the program executed in the MFP in the second embodiment may be stored, in an installable format or in an executable file format, in a suitable non-transitory computer-readable storage medium. The non-transitory computer-readable storage medium may include CD (Compact Disk)-ROMs, FDs (Flexible Disks), CD-Rs (Compact Disk Recordables), DVDs (Digital Versatile Disks), and semiconductor memory devices including flash memories.

The program executed in the image distribution apparatus in the first embodiment or the MFP in the second embodiment may be stored in a computer that is connected to a network, such as the Internet, and downloaded via the network. Such a program may be distributed via the network, such as the Internet.

The program executed in the image distribution apparatus in the first embodiment or the MFP in the second embodiment may be preinstalled in a ROM or the like of the image distribution apparatus or the MFP.

The program executed in the image distribution apparatus in the first embodiment or the MFP in the second embodiment may have a module structure including modules corresponding to each of the functional blocks described above. The functions of each functional block may be realized by reading the program from the storage and executing the program by the processor (for example, CPU). In addition, the realized functions may be loaded in the storage to function as the functional blocks.

Further, the present invention is not limited to these embodiments, but various variations and modifications may be made without departing from the scope of the present invention.

What is claimed is:

1. An interaction system configured to interact with a distribution system and a core system,
said core system comprising a first storage configured to store image data distributed from the distribution system at a predetermined storage location;
said distribution system comprising a processor including:
an acquiring part configured to acquire the image data;
a distributing part configured to distribute the acquired image data to the core system;
a second storage configured to store distribution destination information indicating a storage location of the distributed image data in the core system;
a display control part configured to control a display of information related to the distributed image data and acquired from the core system, based on the distribution destination information; and
a processing part configured to execute a process with respect to the distributed image data.

2. The interaction system as claimed in claim 1, wherein the processing part processes the distributed image data according to a distribution process of the distribution system.

3. The interaction system as claimed in claim 1, wherein the processing part requests modifying the storage location in the core system with respect to the distributed image data.

4. The interaction system as claimed in claim 1, wherein the distributing part reads identification information added to the acquired image data, and determines the storage location based on the read identification information.

5. An image processing apparatus connectable to an image distribution server and a core system via a network, comprising:
a processor,
wherein the processor includes:
a requesting part configured to request acquisition of distribution destination information indicating a storage location of image data distributed from the image distribution server to the core system, with respect to the image distribution server;
an acquiring part configured to acquire the distribution destination information from the image distribution server;
a display control part configured to acquire information related to the distributed image data from the core system based on the acquired distribution destination information, and to control a display of the information related to the distributed image data; and
a processing part configured to process the distributed image data.

6. The image processing apparatus as claimed in claim 5, wherein the processing part sends the distributed image data to the image distribution server, and requests a distribution process of the image distribution server.

7. The image processing apparatus as claimed in claim 5, wherein the processing part requests modifying the storage location in the core system, with respect to the distributed image data.

8. A non-transitory computer-readable storage medium that stores a program which, when executed by a computer, causes the computer to perform an interaction control process of an image processing apparatus that is connectable to an image distribution server and a core system via a network, said interaction control process comprising:
a requesting procedure causing the computer to request acquisition of distribution destination information indicating a storage location of image data distributed from the image distribution server to the core system, with respect to the image distribution server;
an acquiring procedure causing the computer to acquire the distribution destination information from the image distribution server;
a display control procedure causing the computer to acquire information related to the distributed image data from the core system based on the acquired distribution destination information, and to control a display of the information related to the distributed image data; and
a processing procedure causing the computer to process the distributed image data.

9. The non-transitory computer-readable storage medium as claimed in claim 8, wherein the processing procedure causes the computer to send the distributed image data to the image distribution server, and to request a distribution process of the image distribution server.

10. The non-transitory computer-readable storage medium as claimed in claim 8, wherein the processing procedure causes the computer to request modifying the storage location in the core system, with respect to the distributed image data.
